(19) United States
(12) Patent Application Publication
(10) Pub. No.: US 2006/0072325 A1
(43) Pub. Date: Apr. 6, 2006

(54) Motion-activated valve stem light

(76) Inventors: Edward D. Lewis, Brownsburg, IN (US); Eric S. Roberts, Duluth, GA (US); Raymond W. Leung, Fremont, CA (US)

Correspondence Address: BAHRET & ASSOCIATES, 320 NORTH MERIDIAN STREET, SUITE 510, INDIANAPOLIS, IN, 46204, US

(21) Appl. No.: 11/146,421

(22) Filed: Jun. 6, 2005

Related U.S. Application Data
(60) Provisional application No. 60/616,407, filed on Oct. 6, 2004.

(51) Int. Cl. F21V 23/04

(52) U.S. Cl. 362/276

(57) ABSTRACT

A motion-activated valve stem light comprising a housing adapted to fit securely on a valve stem of a vehicle wheel, and a light circuit contained within the housing, the light circuit including an LED, a battery power source, a control circuit connected to the power source and the LED, and a self-contained motion switch connected to an input of the control circuit, wherein the motion switch includes a sealed case, e.g., a button cell case, having first and second conductive terminal portions, an electrical insulator between the terminal portions, and a BB or other conductive member freely movable within the case and adapted to electrically interconnect the conductive terminal portions at a plurality of spaced points within the case. The valve stem light may also or alternatively have a trial activation mechanism including a thin insert which extends through a slot in a male coupling portion of a multi-piece housing and between two batteries when the housing is in a partially assembled state in which the male coupling portion partially engages a mating female coupling portion. Each side of the insert has a battery contact, and the battery contacts are connected to a normally open switch external to the housing. The female coupling portion has a solid sidewall which covers the male coupling portion and thereby covers the slot when the trial activation switch is removed and the coupling portions are fully engaged. In this state an O-ring around the male coupling portion seals the junction of the coupling portions such that the housing is substantially waterproof.

### CROSS-REFERENCE TO RELATED APPLICATION

This application claims the benefit of Provisional Application No. 60/616,407, filed Oct. 6, 2004, which application is hereby incorporated by reference.

### BACKGROUND OF THE INVENTION

This invention relates to decorative and/or safety lighting devices for bicycles, automobiles and other vehicles, and, more particularly, to lights for attachment to a valve stem of a vehicle wheel.

Valve stem lights of various types are known, such as in the following patents which are hereby incorporated by reference:

| Patent No. | Inventor | Issue Date |
|---|---|---|
| 4,800,469 | Leon | Jan. 24, 1989 |
| 4,847,735 | Kawasaki | Jul. 11, 1989 |
| 4,945,337 | Huang | Jul. 31, 1990 |
| 6,359,551 | Suda | Mar. 19, 2002 |
| 6,467,939 | Deutsch et al. | Oct. 22, 2002 |
| 6,527,408 | Korenek | Mar. 4, 2003 |

U.S. Pat. No. 6,359,551 to Suda, U.S. Pat. No. 6,467,939 to Deutsch et al. and U.S. Pat. No. 6,527,408 to Korenek disclose motion-activated valve stem lights, which have the capability of preserving battery life by turning off when the vehicle on which they are mounted is not moving. Existing valve stem lights responsive to motion have been found not sensitive enough to motion in some common applications, however, such as on bicycle wheels. The problem is particularly evident with children's bicycles and during low-speed operation.

Battery drainage during shipment, due to vibration and other motion, is another problem with a motion-activated valve stem light if the product is shipped with batteries installed. A very sensitive motion switch in the valve stem light would exacerbate this problem. A pull-tab insulator has been used between installed batteries in other products to avoid battery drainage during shipment, but such a pull tab conventionally extends into the product through a slot that is left open when the pull tab is pulled out to allow normal use of the product. The batteries and possibly other parts of the interior circuitry of the product are exposed to the elements as a result. A valve stem light should be weatherproof, however, because of its exposure to rain and road spray in wet weather, and thus a slot into the battery area would be considered unsuitable for such a product. A need therefore exists for a design which allows shipment of a sensitive motion-activated valve stem light without draining installed batteries and without sacrificing the weatherproof character of the product.

There is also a need for valve stem lights having improved switch designs providing greater sensitivity to motion while maintaining predictability and reliability of performance and ease of manufacture.

### SUMMARY OF THE INVENTION

The present invention provides, as one aspect thereof, a motion-activated valve stem light comprising a housing adapted to fit securely on a valve stem of a vehicle wheel, and a light circuit contained within the housing, the light circuit including an LED, a power source, a control circuit connected to the power source and the LED, and a self-contained motion switch connected to an input of the control circuit, wherein the motion switch includes a sealed case having first and second conductive terminal portions, an electrical insulator between the terminal portions, and a conductive member freely movable within the case and adapted to electrically interconnect the conductive terminal portions at a plurality of spaced points within the case.

Another aspect of the present invention is a novel trial activation mechanism. According to this aspect of the invention, a motion-activated valve stem light comprises a multi-piece housing adapted to fit securely on a valve stem, the housing including first and second housing portions having respective male and female coupling portions. A slot is provided through a sidewall of the male coupling portion, while the female coupling portion has a solid sidewall. The housing has a partially assembled state in which the male coupling portion engages the female coupling portion leaving the slot exposed, and an assembled state in which the female coupling portion engages and covers the male coupling portion and thereby covers the slot. A light circuit is contained within the housing, the light circuit including an LED and a battery power source. The trial activation mechanism includes a normally open switch external to the housing and a thin insert extending through the slot and between two parts of the light circuit when the housing is in the partially assembled state, the insert having an insulating portion and including an electrical contact connected to each of the two parts of the light circuit and to the normally open switch.

### BRIEF DESCRIPTION OF THE DRAWINGS

FIG. 1 is a cross-sectional side view of a first embodiment of a motion-activated valve stem light according to the present invention.

FIG. 2 is a perspective view of the valve stem light of FIG. 1.

FIG. 3 is a cross-sectional side view of a second embodiment of a motion-activated valve stem light according to the present invention.

FIG. 4 is a perspective view of the valve stem light of FIG. 3.

FIG. 5 is a cross-sectional side view of a third embodiment of a motion-activated valve stem light according to the present invention.

FIG. 6 is a perspective view of a fourth embodiment of a motion-activated valve stem light according to the present invention.

### DETAILED DESCRIPTION OF PREFERRED EMBODIMENTS

For the purpose of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device and such further applications of the principles of the invention as illustrated therein being contemplated as would normally occur to one skilled in the art to which the invention relates.

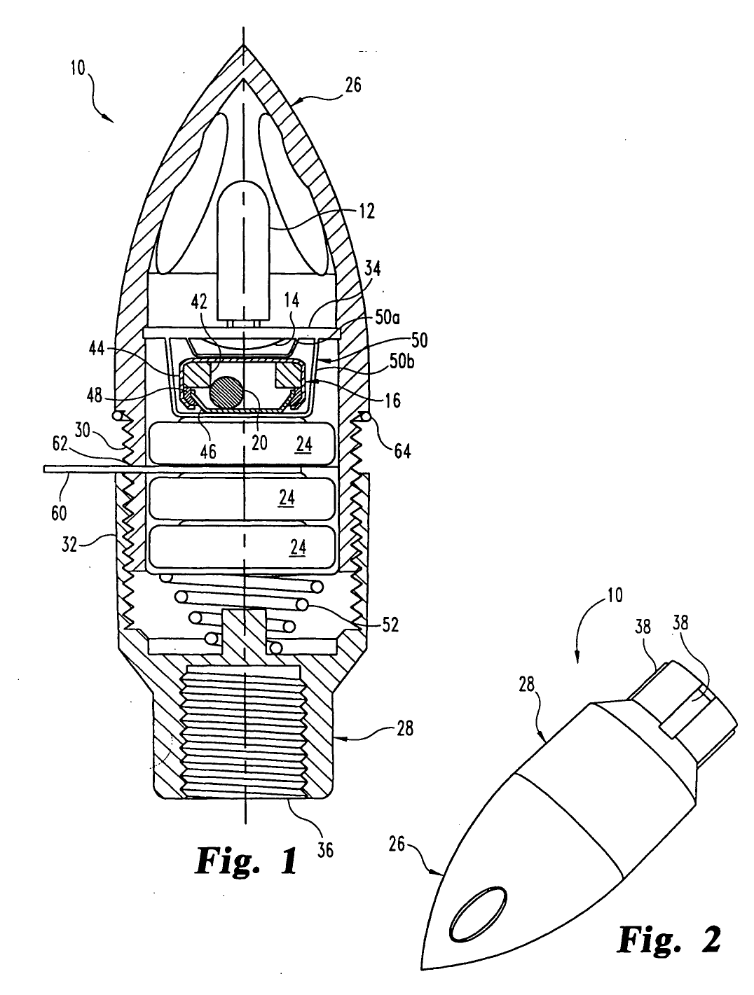

FIGS. 1 and 2 illustrate a first embodiment 10 of a motion-activated valve stem light according to the present invention in which a light-emitting diode (LED) 12 is controlled by an integrated circuit (IC) 14 which is triggered by a motion-activated switch 16 having a ball 20 in a button cell case. A plurality of button cell batteries 24, e.g., AG10 batteries, provide the power for the light circuit, which is contained in a two-part housing with upper and lower housing portions 26, 28 having respective male and female coupling portions 30, 32, both of which are threaded in the disclosed embodiment. The upper housing portion is preferably transparent or translucent plastic, and both housing portions preferably have solid sidewalls except as described herein. The LED and IC are mounted on a printed circuit (pc) board 34 above switch 16, which in this embodiment is in line with the LED, IC and batteries on the longitudinal axis of the housing as shown in FIG. 1.

The valve stem light attaches to a conventional threaded valve stem of a vehicle wheel by means of internal threads 36 in the lower housing portion 28. The vehicle wheel may have a valve stem mounted directly on or in its rim, as in the case of tubeless tires, or the wheel may have a valve stem that protrudes through the rim as part of the inner tube of a bicycle tire or other tire having an inner tube. The mounting threads of the valve stem light may be designed for a Schrader valve or alternatively for a Presta valve or other threaded valve stem. The lower housing may have a plurality of exposed ribs 38 which may be used to tighten the light on a valve stem.

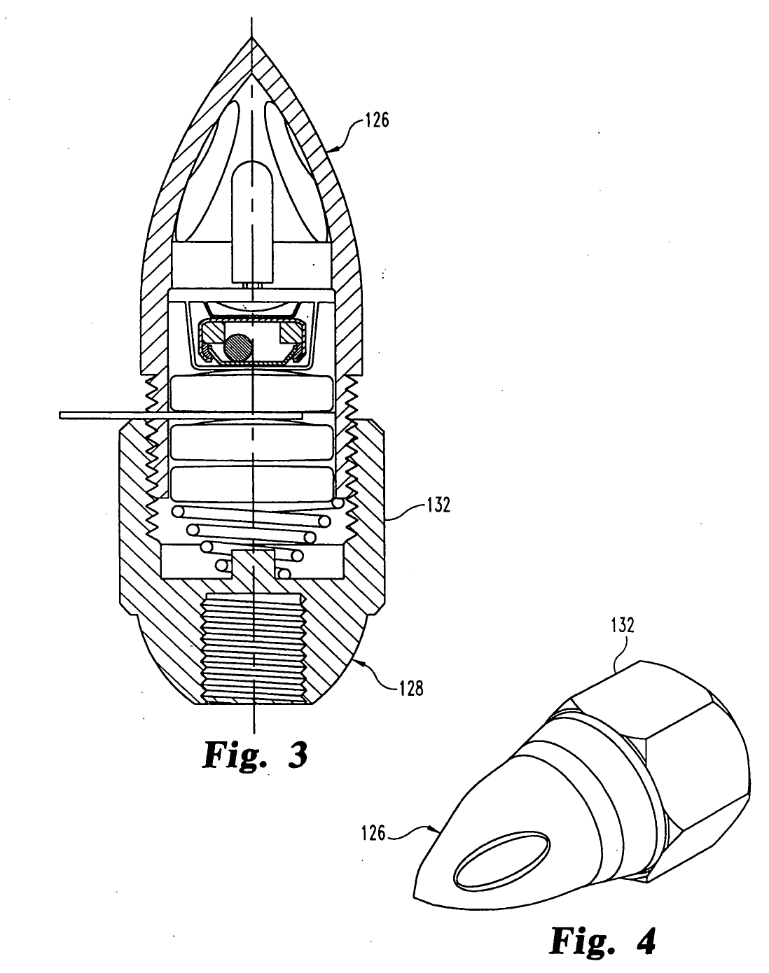

Alternatively, the lower housing 128 may include a hexagonal body portion 132 as in the embodiment of FIGS. 3 and 4, with a threaded connection to an upper housing portion 126 as in the first embodiment. Unthreaded connections are also contemplated, such as friction fit and snap fit connections.

Switch 16 is a self-contained switch suitable for solderless connection to respective contacts on the pc board, whereby the switch may be readily inserted during assembly and readily replaced if necessary. It has a conductive BB 20 or other movable conductive member contained within a modified button cell battery case, preferably an AG3 case. The switch in the disclosed embodiment includes a conductive ring 42 inside and in electrical contact with an anode cup 44 which is insulated from a cathode 46 by an annular insulator 48. The case is otherwise empty except for the BB, which is free to move within the case, both laterally and longitudinally. When the valve stem light is moved or oriented such that the BB simultaneously contacts the cathode and ring 42, the BB makes an electrical connection between the cathode and anode via the ring as illustrated and thereby closes the switch. The two degrees of freedom of the BB within the case permit it to electrically interconnect the cathode and ring at any point on the inner circumference of the ring. The inside of the case may be gold plated for increased conductivity.

Switch 16 may be laterally inserted into a holder 50 which is secured to the pc board and which may have upper and lower contacts 50a,b providing solderless connections to the flat upper and lower portions of anode 44 and cathode 46, respectively, which cross the axis of the housing at right angles. Instead of a contact 50a secured to the pc board at two points, the upper solderless connection to the light circuit on the pc board may be made by means of a spring-biased metal contact (not shown) against the flat top surface of anode cup 44. The anode cup sidewall is spaced apart or insulated from the sidewalls of holder 50b in this embodiment. Holder portion 50b also serves as the contact for the negative terminal of the top battery. The button cell batteries are stacked as shown and held together by a compression spring 52 during use. The positive terminal of the bottom battery is connected to the pc board through a peripheral conductor (not shown) in a conventional manner, with the peripheral conductor spaced apart or insulated from the sidewalls of the other batteries.

The IC for this embodiment is preferably configured to operate in true one-shot mode, i.e., as a non-retriggerable one-shot, whereby, once triggered, the one-shot cannot be triggered again during the timing interval and times out at the end of that interval. The IC is preferably edge-triggered but may be otherwise configured so as to require the switch to change state twice, e.g., to open and then close again, in order to trigger the IC after it has timed out. One suitable IC is available in die form, as part number wel62-7, from Winfar Electronics Co., Ltd, Shenzhen, China. With this type of IC and the disclosed BB switch, the valve stem light is highly sensitive to motion of the wheel on which it is mounted but times out and turns off after the wheel stops moving, regardless of its orientation at that time.

The valve stem light advantageously includes a trial activation switch mechanism which may include a normally open membrane switch (not shown) external to the housing, the switch having two contacts electrically connected to spaced contact points on a small pc board 60 or other material suitable for insertion in a slot 62 provided for this purpose in the sidewall of male coupling portion 30. The spaced contact points are preferably on opposite sides of the pc board. The slot is exposed when the valve stem light is in a partially assembled state in which the male coupling portion partially engages the female coupling portion as illustrated, and, in that state, the insert 60 extends through the slot and between two parts of the light circuit, such as between two of the batteries as shown in FIG. 1.

The trial activation switch external to the housing is effectively connected in series with motion switch 16 in the partially assembled product, whereby, when the trial activation switch is open, the light circuit is disabled, but, when the trial activation switch is closed, the light circuit is responsive to the motion switch and may be tested by a prospective customer. Such a trial activation switch may be included in packaging for the product, which may be sealed with installed batteries inside a blister pack, for example, with the membrane switch left exposed for prospective customers to use to test the product before purchase. The trial activation switch allows such testing while preventing battery drainage as might otherwise occur due to motion during shipment.

The female coupling portion has a solid sidewall which covers the male coupling portion and thereby covers the slot when the trial activation switch is removed and the lower housing portion is fully screwed onto the upper housing portion. In this fully assembled state the connection between the upper and lower housings is sealed by an O-ring 64, which may be made of silica gel, and the housing is substantially waterproof. This embodiment of the invention thus allows shipment of a sensitive motion-activated valve stem light without draining installed batteries and without sacrificing the weatherproof character of the product.

A valve stem light with such a trial activation mechanism is useful with a BB switch as described above, or with other types of motion switches in certain applications. For example, the valve stem light may employ a coil spring switch such as disclosed in U.S. Pat. No. 6,419,384 to Lewis et al., which patent is incorporated herein by reference. A suitable IC for such an embodiment is a type AP3761-03 IC, commercially available in die form from Advanced Microelectronic Products, Inc., Taiwan. With a normally open spring switch, the IC may be configured to operate in a retriggerable one-shot mode such that it is triggered when the switch first closes and is retriggered as long as the switch remains closed. The one-shot times out, and thus the LED turns off, a set period of time after the switch is opened. The IC may be configured to operate in one-shot mode generating a predetermined number of flashes or sequential ON intervals in a predetermined period of time in response to a trigger signal. So configured, the light circuit effectively creates moving bars of light on a revolving bicycle wheel.

In another contemplated embodiment, the light circuit has a bicolor or tricolor LED which is controlled by a suitable LED driver so as to sequentially produce bars of light in different colors, thereby producing a rainbow effect as described more fully in U.S. Pat. No. 6,206,537 to Hauck, which patent is hereby incorporated by reference. Likewise, a plurality of valve stem lights may be used to create the appearance of moving bars of light, providing amusement to the rider of the bicycle and others.

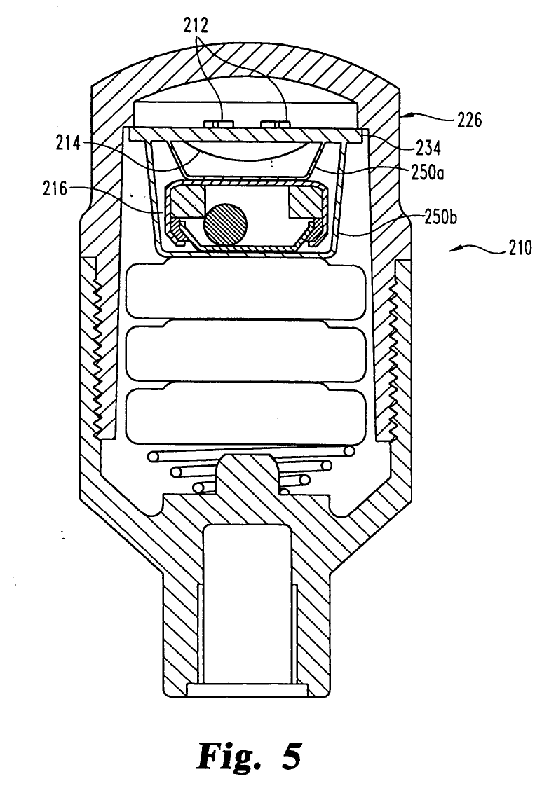

FIG. 5 shows another embodiment of a valve stem light 210 which has a plurality of surface-mounted LEDs 212, e.g., chip-on-board (COB) LEDs, on the top surface of a pc board 234 inside a lower-profile upper housing portion 226 than in the embodiments described above. The LEDs may be connected in parallel or may be sequentially energized by an IC 214 which, as in the light circuit described above, is triggered by a BB switch 216. The switch in this embodiment is held with an interference fit by a board-mounted holder having upper and lower contacts 250a,b which electrically connect the switch terminals to respective points in the light circuit, e.g., to ground and to the trigger input of the IC. Alternatively, the upper contact of the holder may be a spring-based contact secured on one end in this embodiment and the other embodiments described herein. The valve stem light according to this embodiment may otherwise be the same as the embodiments described above.

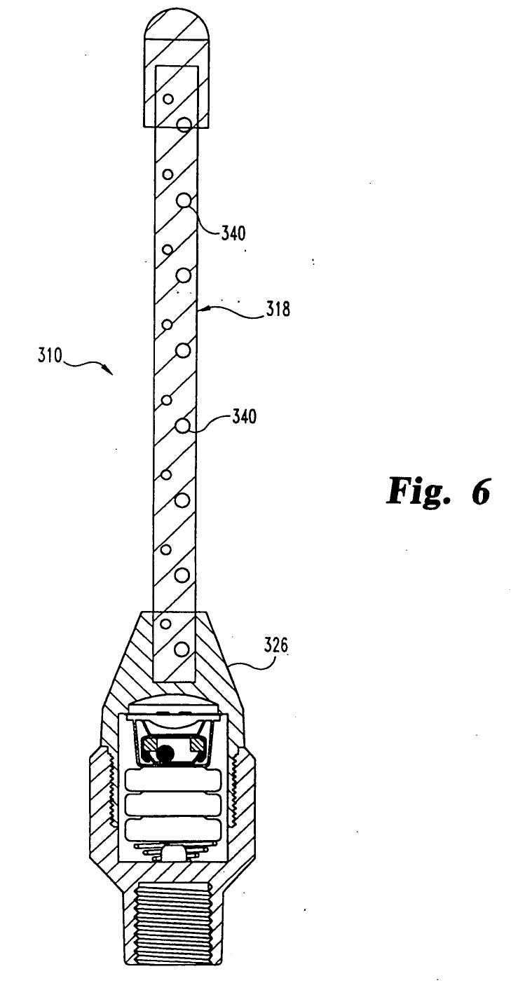

FIG. 6 shows an embodiment of a valve stem light 310 having a COB LED as in the embodiment of FIG. 5, but having a transparent or translucent plastic bubble rod 318 extending longitudinally from the upper portion 326 of the housing, which may otherwise be the same as in the other embodiments described above. The bubble rod may have a cylindrical column shape, although other cross-sectional shapes and longitudinally curved shapes are also contemplated, and is preferably made of a durable transparent material such as acrylic with a plurality of irregularly spaced voids or bubbles 340 for light scattering. The bubbles may be created by introducing air into the mold during the extrusion process. The rod may be about 3/16 inch wide and 3 inches long. Light impinging on a given bubble from the LED is refracted and/or reflected by the bubble, thereby increasing the visibility of the bubble as well as that of the entire length of the rod.

As an alternative to a bubble rod which is suitable for certain applications, the transparent rod may have a plurality of laser-etched or laser-cut lines along its length that accentuate the illumination produced by the LED. More specifically, such lines may be formed parallel to the longitudinal axis of the rod for the purpose of transmitting light from the LED through the rod in distinguishable lines and radiating such light radially therefrom.

While the invention has been illustrated and described in detail in the drawings and foregoing description, the same is to be considered as illustrative and not restrictive in character, it being understood that only the preferred embodiments have been shown and described and that all changes and modifications that come within the spirit of the invention are desired to be protected. For example, the BB switch may be oriented with its anode side down for certain applications, such that the internal conductive ring is on the side closer to the batteries, although the orientation shown in FIG. 1 is preferred for childrens' bicycles among other applications. Also, the male coupling portion may be on the lower housing portion rather than on the upper housing portion as shown in FIG. 1.

What is claimed is:

1. A motion-activated valve stem light, comprising;
a housing adapted to fit securely on a valve stem of a vehicle wheel, said housing having a longitudinal axis; and
a light circuit contained within said housing, said light circuit including an LED, a power source, a control circuit connected to said power source and said LED, and a self-contained motion switch connected to an input of said control circuit;
wherein said motion switch includes a sealed case having first and second conductive terminal portions, an electrical insulator between said terminal portions, and a conductive member freely movable within said case and adapted to electrically interconnect said conductive terminal portions at a plurality of spaced points within said case.

2. The motion-activated valve stem light of claim 1, wherein said case is a button cell case.

3. The motion-activated valve stem light of claim 1, wherein said conductive member has at least two degrees of freedom within said case of said motion switch.

4. The motion-activated valve stem light of claim 3, wherein said conductive member is a ball, and wherein said case has an open space therein with a substantially circular cross-section greater in diameter than said ball and with a height along said housing axis greater than the diameter of said ball, whereby said ball has three degrees of freedom within said case.

5. The motion-activated valve stem light of claim 4, wherein said housing has an open lower end for attachment to said valve stem;
wherein said motion switch has flat upper and lower terminal surface portions perpendicular to said housing axis and further includes a conductive ring within said case in electrical contact with said flat upper terminal surface portion and spaced from said flat lower terminal surface portion; and
wherein said ball is sized to interconnect said flat lower terminal surface portion and said conductive ring.

6. The motion-activated valve stem light of claim 5, wherein said case is a button cell case.

7. The motion-activated valve stem light of claim 6, wherein said power source includes a plurality of button cell batteries.

8. The motion-activated valve stem light of claim 7, wherein said housing includes first and second housing portions having respective male and female coupling portions, said male coupling portion having a slot through a sidewall thereof, said female coupling portion having a solid sidewall; and
wherein said valve stem light has a partially assembled state in which said male coupling portion engages said female coupling portion leaving said slot exposed, and an assembled state in which said female coupling portion engages and covers said male coupling portion and thereby covers said slot;
further comprising a trial activation mechanism including a normally open switch external to said housing and a thin insert extending through said slot and between two of said batteries when said valve stem light is in said partially assembled state, said insert having an insulating portion and including an electrical contact connected to each of said two batteries and to said normally open switch.

9. A motion-activated valve stem light, comprising;
a housing adapted to fit securely on a valve stem of a vehicle wheel, said housing including first and second housing portions having respective male and female coupling portions, said male coupling portion having a slot through a sidewall thereof, said female coupling portion having a solid sidewall, said housing having a partially assembled state in which said male coupling portion engages said female coupling portion leaving said slot exposed, and an assembled state in which said female coupling portion engages and covers said male coupling portion and thereby covers said slot;
a light circuit contained within said housing, said light circuit including an LED and a battery power source; and
a trial activation mechanism including a normally open switch external to said housing and a thin insert extending through said slot and between two parts of said light circuit when said housing is in said partially assembled state, said insert having an insulating portion and including an electrical contact connected to each of said two parts of said light circuit and to said normally open switch.

10. The motion-activated valve stem light of claim 9, wherein said power source insert includes a plurality of button cell batteries and said insert is connected between two of said batteries.
